(19) United States
(12) Patent Application Publication
(10) Pub. No.: US 2012/0098247 A1
(43) Pub. Date: Apr. 26, 2012

(54) Method of Creating and Exhibiting Fluid Dynamics

(75) Inventor: Barry Lee Petersen, Castle Rock, CO (US)

(73) Assignee: CELSIA, LLC, San Jose, CA (US)

(21) Appl. No.: 12/910,953

(22) Filed: Oct. 25, 2010

(51) Int. Cl. G09B 29/00

(52) U.S. Cl. 283/67; 283/34

(57) ABSTRACT

Embodiments of the disclosed technology comprise a general method and device for designing a nearly unlimited range of return flow fluid dynamics systems. Additionally, it allows an improved method for designing GHX (ground heat exchange) field designs. An entire piping system can be developed from two components: a load circuit with multiple optional fittings, and a supply/return Pipe Pair with a multiple optional fittings on each pipe. These units can be linked together in the computer interface workspace, emblematic of a three dimensional GHX field design. As a designer links these components together, the piping system expands in size and complexity. Regardless of the complexity of the designed system, the embodiments of the disclosed technology determine the relationship between individual components, families of components and the overall GHX field. A diverse range of fluid dynamics results and an automatic sizing system is developed in embodiments of the disclosed technology.

### FIELD OF THE DISCLOSED TECHNOLOGY

The disclosed technology relates generally to fluid flow piping systems and, more specifically, to methods of creating and exhibiting the pipe arrangement.

### BACKGROUND OF THE DISCLOSED TECHNOLOGY

Piping systems are used in all types of engineering or scientific applications. There are many ways to represent the piping component arrangement with spreadsheets, dedicated software or other calculation tools. However, in some dynamic piping fluid flow applications, the fluid cycles through the system and continuously returns to a particular starting point. In these systems, the fluid can be described as having a supply and return component, whereby the supply is the outgoing component of the flow, and the return is the part of the flow that returns back to the start. Usually, the fluid in the continuous loop flows through some type of load (herein, “circuit”), either in parallel or series, and then returns to the source. Factory processes, heating, ventilation, and air conditioning systems commonly employ this type of piping arrangement.

Currently, most systems that involve supply and return flow require a direct depiction of both the supply and return components in some sort of diagram or list on a spreadsheet. Changes in piping number, sizes or directions require complicated independent changes in manually drawn diagrams or lists that can be complicated to implement and change. Since the underlying fluid dynamics equations are intrinsically bound to the physical arrangement, modifications also generally require modifications to the fluid dynamic computational model employed.

Piping optimization is also an essential and oftentimes overlooked component in competent geothermal loop design. When designed correctly, a piping system will be easy to purge and provide the flow characteristics essential for efficient heat transfer during standard operation—all while minimizing pumping and operational costs. Until now, piping optimization in the geothermal field has been a time-consuming, difficult and iterative process. As in other piping system applications, the present state of the art for geothermal piping design is based on homegrown spreadsheets, rule of thumb estimates, and piping specification sheets. Indeed, it could easily take an experienced designer half a day or more to try to optimize a mid-sized commercial design. Modeling reverse return systems with any accuracy is particularly difficult when using spreadsheets and hand calculations. What is needed in the art is a way to model piping systems in a simple manner, while allowing for dynamic changes to be made.

### SUMMARY OF THE DISCLOSED TECHNOLOGY

To improve upon the prior art deficiencies, it should be possible to use the inherent nature of the supply and return relationship to make effective unit “building blocks” that can be used to quickly construct models of piping systems. Diagram elements may then hold particular piping physical characteristics, and the arrangement of the piping system only depends on the linear placement of the separate units. This technology greatly eases the problems of drawing and modifying diagrams because the separate units and their relationships hold all of the information necessary for computing all related fluid dynamic calculations required by people using the tool.

An object of the present technology is to use elements to represent supply and return components and loads in a fluid dynamics piping layout.

Another object of the present technology is to use a visual interface for describing any possible geothermal field configuration, including direct and reverse return ground heat exchangers, supply and return runouts, manifolds, vaults, circulation pumps, and the fittings that connect the aforementioned components.

Another object is to provide definable characteristics for each and every part of a geothermal loop.

Yet another object is to provide a pre-defined optimization piping design to automatically and quickly create or update a geothermal loop design.

In embodiments of the disclosed technology, based on visualization, the proper supply and return header piping reductions are calculated to ensure that user-defined purging flow rates are maintained throughout any piping design. A user may look at a variety of fluid dynamics characteristics for each and every part of the design. These characteristics include pipe length, pipe size, flow rate, velocity, fluid volume, Reynolds number and pressure drop among others. If the user needs to make a minor or major modification to the auto-calculated system (such as manually changing the diameter of a particular pipe section), he or she is able to do so easily and then view the impact of the change on the overall system.

Embodiments of the disclosed technology allow for the visualization and building of a geothermal piping system/geothermal field design/manifold using two components—a pipe and a GHX (ground heat exchange) circuit, as defined in the detailed description. In embodiments, a two-dimensional interface is provided to carry out the placement and linking of pipes and GHX circuits, herein defined as the “essential components.” The essential components can be linked together in any configuration to build a complex system. As each essential component is added, or the specifications of a component are modified, flow rate, temperature, and other predicted characteristics of fluid flow are modified for each component in a GHX configuration.

A linear map of a pipe system, in an embodiment of the disclosed technology, has at least one single indicator representative of both a supply flow pipe and a return flow pipe. At least one circuit pipe, or “load”, (as represented on the linear map) of the pipe system is connected between the supply and the return pipe. Further, the linear map has at least one indicator representative of a circuit pipe. Placement of each of the indicators is in a linear manner (such as left to right, right to left, or top to bottom, written in any orientation), indicative of a linear direction of flow of fluid through at least a part of the pipe system. Placement of each indicator in a linear manner is referred to, in this disclosure, as being on different “levels” or different “lines”. At each level or line, a new flow path is depicted/created. The linear/leveled direction of flow refers to flow between at least two pipes of the pipe system, that is, from one pipe to the next. In the linear map, some such pipes are adjacent to each other, but some may not be, depending on the embodiment, as is explained further in the detailed description.

In embodiments, one indicator per line is depicted on the linear map. Placement of at least one indicator representative of a circuit pipe is offset transversely to the linear direction, in embodiments, indicating supply and return of flow to a preceding return pipe. That is, for example, when the linear direction is “up to down,” a transverse direction may be an indentation to the right for a circuit pipe (child pipe to the parent supply pipe).

In embodiments, a single indicator representative of both a supply flow pipe and a return flow pipe corresponds to direct flow, and another single indicator representative of both a supply flow pipe and a return flow pipe corresponds to reverse return flow. Connectors between two indicators, when used, correspond to a path of flow between pipes represented by the indicators.

The linear map is manipulatable by way of selection of indicators on the linear map, in embodiments of the disclosed technology. To make the map manipulatable, a computer mouse or input device may be used in conjunction with an electronic display. A selection of an indicator associated with a supply and return flow pipe removes from exhibiting all indicators representative of child pipes of the selected pipe, in embodiments. A child pipe is one which receives downward flow from a prior pipe, that is, a parent pipe which is upstream.

In embodiments, a selection of an indicator allows for a change in properties of a pipe of the pipe system, wherein, when fluid dynamics equations are applied on the system as a whole, such a change causes a cascaded update of the calculated properties of other pipes in the system. One such property is pipe diameter.

The linear map may be in the form of a hierarchical tree.

The above described (two-dimensional) linear map may be created and manipulated by way of the following method. At least one single indicator representative of both a supply flow pipe and a return flow pipe is exhibited (displayed or written), whereby at least one circuit pipe of the piping system is connected between the supply and the return pipe. At least one indicator representative of a circuit pipe is further exhibited. Placement of each of the indicators is in a linear directional manner, indicative of a direction of flow of fluid through at least a part of the piping system. Other features of the linear map, described above, are also applicable to the method.

Further, each manifold consists of at least one supply pipe, a return pipe and any number of fittings (connectors) between the components. Each of these components and essential components is user-definable. Each manifold has a supply and return runout pipe pair.

Thus, a dynamic model of a geothermal system is created which is dynamically editable and changeable, allowing all other components to be updated simultaneously.

Further elements of the device of the disclosed technology are applicable to embodiments of the method of the disclosed technology.

### BRIEF DESCRIPTION OF THE DRAWINGS

FIG. 1 shows a geothermal ground loop of embodiments of the disclosed technology.

FIG. 2 shows a diagrammatic view of a GHX manifold created in embodiments of the disclosed technology.

FIG. 3 shows a single GHX circuit of embodiments of the disclosed technology.

FIG. 4 shows an individual supply and return pipe pair.

FIG. 5 shows a plurality of GHX circuits in an embodiment of the disclosed technology.

FIG. 6 shows how the GHX circuits of FIG. 5 are diagrammed in an embodiment of the disclosed technology.

FIG. 7 shows a reverse return GHX system in embodiments of the disclosed technology.

FIG. 8 shows a diagram of the reverse return system of FIG. 7.

FIG. 9 shows a complex four-circuit direct-return GHX Module.

FIG. 10 is a diagrammatic view of the complex four-circuit direct-return GHX Module shown in FIG. 9, as created in embodiments of the disclosed technology.

FIG. 11 shows a high level diagram of a device on which methods of the disclosed technology are carried out in embodiments of the disclosed technology.

### DETAILED DESCRIPTION OF EMBODIMENTS OF THE DISCLOSED TECHNOLOGY

Embodiments of the disclosed technology comprise a method and device for designing a nearly unlimited range of GHX (ground heat exchange) field designs. An entire piping system can be developed from two components: a circuit with multiple optional fittings (inlet/end/outlet), and a supply/return Pipe Pair with multiple optional fittings on each pipe. These units can be linked together in a two-dimensional diagrammatic workspace, such as displayed on paper or on a video screen of a computational device, the diagram emblematic of a three dimensional GHX field design. As a designer links these components together, the piping system expands in size and complexity. Regardless of the complexity of the designed system, the embodiments of the disclosed technology determine the relationship between individual components, families of components and the overall GHX field. A diverse range of fluid dynamics results, or an automatically-sized system is developed in embodiments of the disclosed technology, to satisfy a designer's requirements (such as by determining length, circumference, and layout of supply and return header systems to ensure a desired flow rate throughout, e.g., 2 ft/s for purging effectiveness).

Embodiments of the disclosed technology will become clearer in view of the description of the following figures.

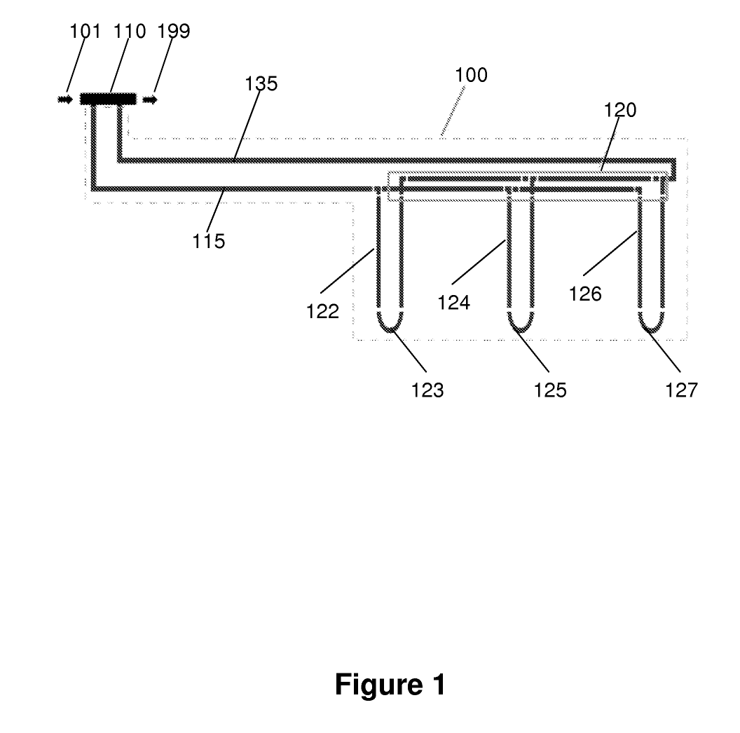

FIG. 1 shows a geothermal ground loop of embodiments of the disclosed technology. The device depicted will be referred to as a ground heat exchanger 100, and may include a vertical, horizontal trenching, horizontal boring, pond or lake heat exchanger buried in the ground or submerged in a body of water. The ground heat exchanger 100 will be abbreviated as GHX throughout the remainder of this disclosure. It should be understood that a geothermal ground loop is one type of return flow piping system with a load. Embodiments of the disclosed technology are applicable to any type of return flow piping system with a load (also known as “circuit” in this disclosure), such as a heating system, cooling system, municipal water/sewer system, or the like. The “fluid” used is the medium passing through the system, such as water, oil, air, or the like.

Below, the elements shown in FIG. 1 will be defined in detail, but for purposes of understanding the figure, a brief overview is provided herein before the definitions. Water (or another fluid) enters the system from a building at entrance 101 into the GHX manifold or vault 110 and exits back to the building at outlet 199. However, part or all of the fluid enters a GHX module supply runout 115 and then passes into the GHX circuits 122, 124, and 126 (any number of circuits may be used). A GHX header 120 connects the supply and return runout piping and GHX circuits in serial, in parallel, or in such a manner as to allow equal pressure (or at near or substantially equal pressure, defined as within a tolerance set by a user and usually not more than 10% different per circuit) of fluid in each circuit 122, 124, and 126. Fluid then exits the GHX header 120 and returns via GHX module return runout 135 where the fluid then enters back into the building via outlet 199. The circuits are buried beneath the ground (in some cases, hundreds of feet below the ground), where the ambient temperature is different from that of the surface (usually, cooler beneath the surface) which causes the fluid to decrease in temperature and cool the building upon return of the fluid which passed beneath the surface of the earth.

For purposes of this disclosure, the following definitions are provided:

GHX Circuits 122, 124, 126: Pipes (such as HDPE, high-density poly-urethane) buried in the ground in horizontal or vertical orientation designed to transfer energy to and from the ground. Typically a number of GHX Circuits are fusion-welded to a GHX Header 120 that is, in turn, fusion-welded to a Supply-Return Runout 115/135. Heat transfer fluid is circulated through the assembly to a building.

U-Bend End Fitting 123, 125, 127: a molded, purpose-built U-bend fitting.

GHX Header 120: Connection points between Supply-Return Runout piping 115/135 and GHX Circuits 122, 124, 126. GHX Headers are buried in the ground adjacent to the GHX Field (definition below) and are comprised of an assembly of fusion-welded fittings and pipe. Fittings and pipe are manufactured using HDPE resin and are connected using heat fusion (butt fusion, socket fusion or electro-fusion), in embodiments of the disclosed technology.

Supply-Return Runout 115/135: Supply-Return Runout refers to the high-density polyethylene (HDPE) piping installed to connect the GHX Circuit piping to the Pump House header. The Supply-Return Runout has both a supply pipe and a return pipe.

GHX Manifold 110: Connection point for Supply-Return Runout piping from GHX field. A GHX Manifold is typically located inside a building or in a geothermal Vault located away from the building.

GHX Module 100: Completed assembly of GHX components, including GHX Supply and Return Runouts, GHX header and GHX Circuits.

GHX Field: Assembly of all GHX Modules connected to a single building or group of buildings via GHX Manifold(s)/Vault(s).

Before delving further into the details of embodiments of the disclosed technology, it is important to understand the following fluid dynamics terminology, all of which can be modified or set as a desired value in a GHX system:

Size: This refers to pipe diameters for the selected components, such as one or a plurality of pipes in a manifold.

Length: Pipe lengths for components selected.

Flow Rate: Rates at which liquid is expected to pass through a pipe.

Velocity: The velocity at which liquid is expected to pass through a pipe.

Reynold's Number: a dimensionless number that gives a measure of the ratio of inertial forces to viscous forces and consequently quantifies the relative importance of these two types of forces for given flow conditions.

Volume: Total amount of fluid one or more selected pipes hold.

Pressure Drop: When a user selects Pressure Drop, all of the pressure drops within the selected component types.

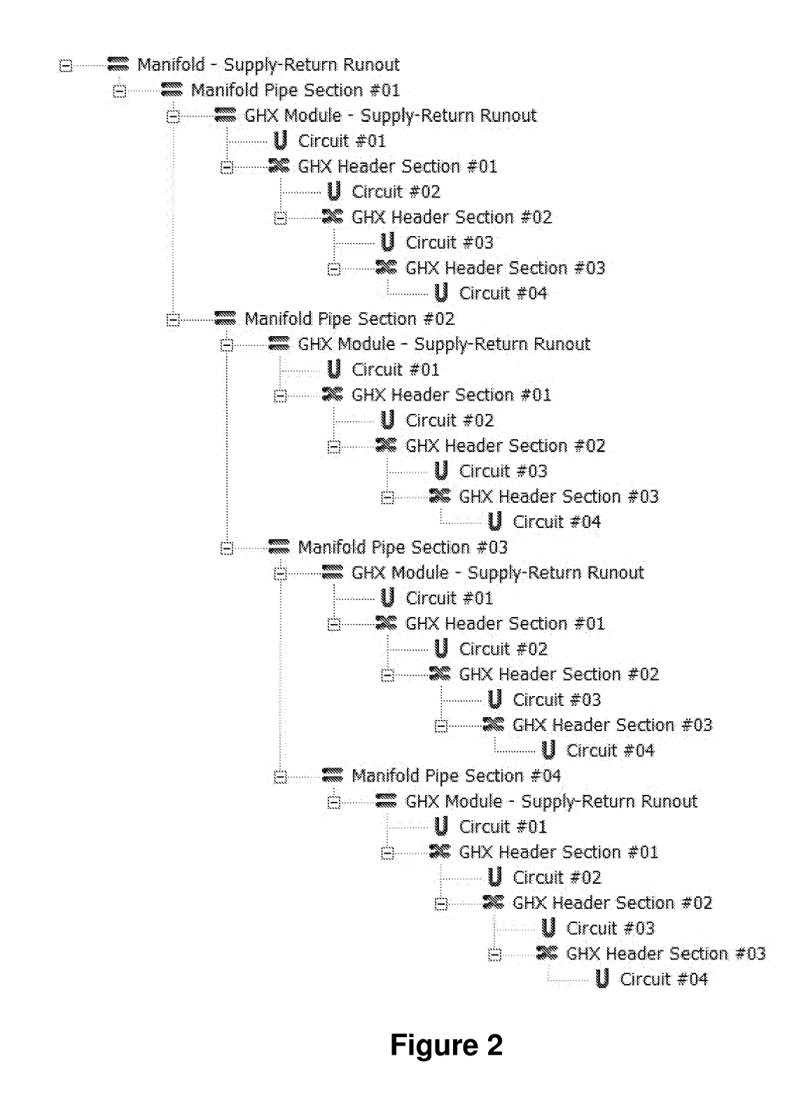

FIG. 2 shows a diagrammatic view of a GHX manifold created in embodiments of the disclosed technology. The example shown in FIG. 2 may be of a manifold which comprises the elements shown in FIG. 1. That is, FIG. 2 is a more complex version of what is shown in FIG. 1. The manifold here has pipe sections #01-#04, each of which forms its own module with a plurality of GHX headers and circuits. In this manner, even a complex GHX device or system can be mapped in an intuitive and easy to read manner. Further, as described below, a user may add or modify an individual element of the manifold, including type of fluid, diameter of pipe, or the like, and any other variable, such as those defined above, may be determined. Thus, in a method of the disclosed technology, a GHX manifold, or a part thereof, is exhibited in a hierarchical tree, and the desired value for any element or piece of the GHX manifold is defined and displayed, and other values are modified accordingly to achieve the final result. More details as to which elements and pieces of the GHX manifold may be manipulated to achieve these goals are provided with respect to the later figures.

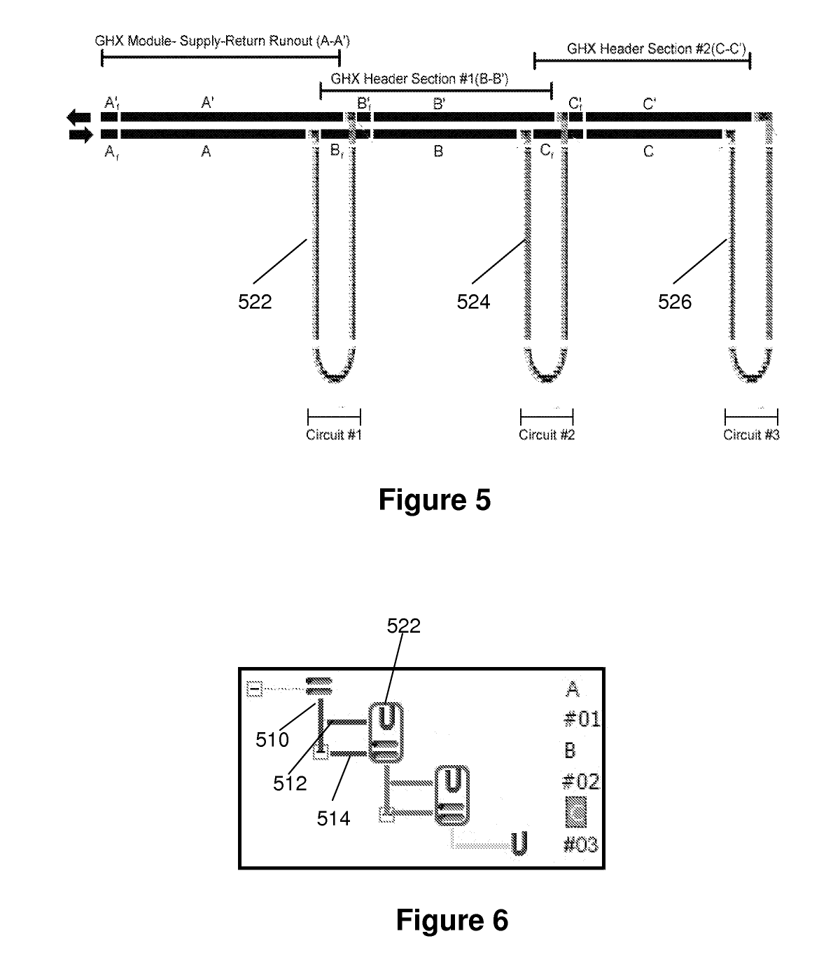

Each component, save the last one, is a parent to other components. A component that has one or more directly connected “downstream” components is a “parent.” All components except the last component in a flow path play the role of parent component. Each component, save the first one, is a child to other components. A “child” has a directly connected “upstream” parent. Most components have a “sibling.” That is, two components which share the same direct parent are called siblings. A change in any component or element of a component causes a change in that component and every other parent, child, and sibling. (The effect of a change on a parent/child/sibling is explained in more detail in FIG. 5.)

Thus, in FIG. 2, those elements which are vertically aligned under the same parent are siblings (e.g. “Circuit #02” and “GHX Header Section #02”). Those elements which are indented beneath/have a connector (shown as an L-shaped line) between them are parent/sibling (e.g., “Circuit #02” is a child of its parent, the “GHX Header Section #01”). The connector between this described parent/sibling pair extends down from the parent and over to the right until reaching the name and/or icon of the child. This method of mapping allows for a relatively simple and straightforward visual depiction of an otherwise complex system depicted beneath the surface. As will now be described in more detail, a change in a property of one of the elements depicted in FIG. 2 (including sub-elements not shown), such as the size or type of a fitting, affects flow rate and other characteristics of almost every, or every, other element.

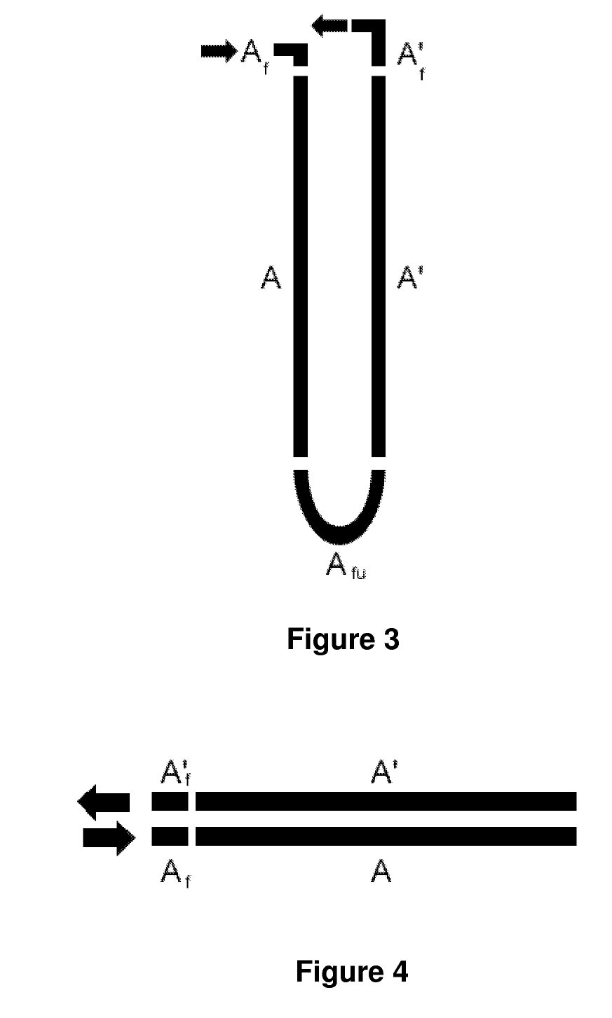

FIG. 3 shows a single GHX circuit of embodiments of the disclosed technology. As described above, at least three fittings (an inlet, end (or, for example, U-Bend End Fitting), and outlet are present in each GHX circuit. In embodiments of the disclosed technology, one or more of the following elements of a GHX circuit may be modified in a diagram, such as that shown in FIG. 2:

Af—Fitting for attachment to supply pipe;

A—Supply side pipe;

Afu—End fitting that connects Pipe A and Pipe A′;

A′—Return side pipe (usually length A=length A′)

A′f—Fitting for attachment to return pipe;

Arrows indicate supply/return flow directions. The space between components is shown for illustration purposes, though one skilled in the art will understand that the components, and those of other figures, are in one continuous fluid loop. This circuit corresponds, for example, to elements of the circuit labeled 122 and 123 of FIG. 1.

Still further, for the fittings, in embodiments of the disclosed technology, elements thereof may be further defined, such as a fitting type (socket tee branch, butt tee branch, etc.), pipe size, equivalent length, and so forth. For the pipes (A and A′), one can further define, in embodiments of the disclosed technology, a pipe size, type, inner diameter, outer diameter, length, extra pipe length, name, and volume. In embodiments of the disclosed technology, based on one selected variable (such as one pipe diameter), other variables of this component and adjacent or fluidly connected components may be defined automatically or as a result of the first selected variable.

FIG. 4 shows an individual supply and return pipe pair. The components share the same labels as that of FIG. 3 and refer similarly to the respective parts (fittings, supply side pipe, and return side pipe). This pipe pair corresponds to labels 115 and 135 of FIG. 1.

FIG. 5 shows a plurality of GHX circuits in an embodiment of the disclosed technology. The circuits have numbers 522, 524, 526 (corresponding to the circuits of FIG. 1, incremented by a multiple of 100) and have supply pipes, U-Bend End Fittings, and return pipes. The supply pipes A, B, and C bring fluid to the circuits, the fluids being returned by return pipes C′, B′, and A′. At the juncture of A and circuit 522, fluid may either enter circuit 522 or continue on to B. The fluid exiting from circuit 522, in this example of a parallel circuit, exits into the return pipe A′. Similarly, the fluid that continued on to B may enter circuit 524 and continue onto C. The fluid from circuit 524 goes on to the return pipe B′, the fluid from C continues into circuit 526 and on to the return pipe C′. Note that the piping shown actually shows crossovers of pipes. That is, when exiting from circuit 524, for example, the dashed pipe of 524 continues to an outlet which has a juncture between B′ and C′ and does not connect to the supply pipes.

FIG. 6 shows how the GHX circuits of FIG. 5 are diagrammed in an embodiment of the disclosed technology. Circuit “#1” (designated also as 522 in FIG. 5) has a U-shaped icon representative of the circuit 522 and an “=”-shaped (equal sign shaped) icon representative of the supply and return pipe for the circuit. Circuit 522 has been labeled as such in FIG. 6 and corresponds to the circuit 522 shown in FIG. 5. To indicate the connection of the circuits in the manifold, line 510 comes down from the parent supply/return pipe (such as one going to and from a building) at 510, and, as shown in the diagram, is indented/placed transversely via 512 to the circuit 522, and 514 to the corresponding supply/return pipe (in this case, A and A′ of FIG. 5). While not labeled in FIG. 6, this is similarly shown for circuits 524 (“#02”) and 526 (“#03”). In this manner, a complex piping system is diagrammed, the child being indented under the parent, and the siblings extending from the same parent and lined up together. One skilled in the art should appreciate that this relatively simple-looking view conveys all of the information of FIG. 5 with none of the confusion as to connection, piping, etc., and that editing a design for a GHX system is much simplified. Further, one skilled in the art should appreciate that a change to a component or element of FIG. 6 will cause a change to the entire system shown in FIG. 5, since the pressure drop change caused by the change (by changing friction, radius, length, etc.) changes the pressure at other places, thereby affecting system flow, velocity, etc.

To recap, FIG. 6 shows the following: Pipe Pair A: Parent to Circuit #1 and Pipe Pair B; Circuit #1: Child to Pipe Pair A, Sibling of Pipe Pair B; Pipe Pair B: Child of Pipe Pair A, Sibling of Circuit #1; Circuit #2: Child of Pipe Pair B, Sibling of Pipe Pair C; Pipe Pair C: Child of Pipe Pair B, Sibling of Circuit #2; Circuit #3: Child of Pipe Pair C.

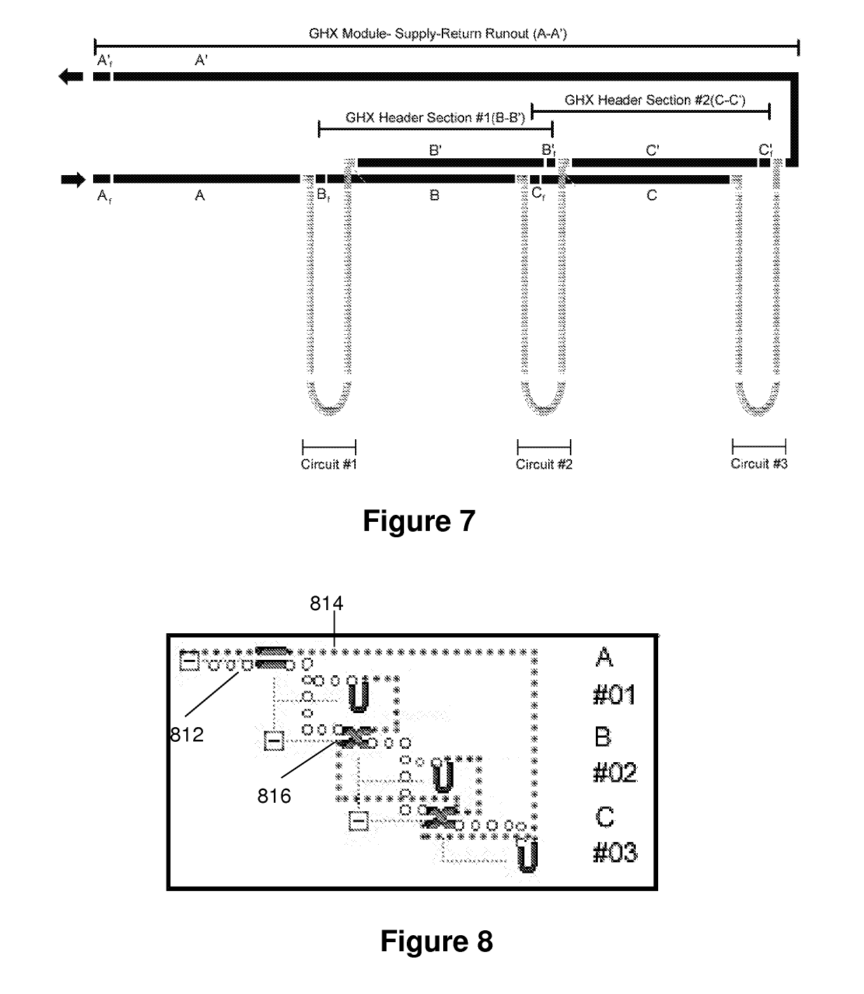

Before describing further figures, it should be understood that the circuit shown in FIG. 5 is one comprising a direct return flow path. Direct return GHX headers (see 120 of FIG. 1 and the definition provided in the description thereof) generally are easier to design, easier to build and may require less total pipe (and hence offer a lower total pressure drop) compared to reverse return GHX headers. The return pipe of the GHX Module Supply-Return Runout may be shorter in the direct return case compared to the reverse return case. If a reverse return GHX Header system, which is shown in FIG. 7 and described below, may be designed to include an extra length, the length of return pipe of the GHX Module Supply-Return Runout in the reverse return system could be nearly the same as the return pipe of the GHX Module Supply-Return Runout in the direct return system, thereby reducing the lower pressure drop benefit associated with direct return systems, depending on the embodiment designed. However, there are cases where the circuits themselves may be placed in a circle, or “horseshoe” arrangement, such that the piping is approximately equivalent for direct and reverse return systems.

In a direct flow path, such as that of FIG. 5 and as diagrammed in FIG. 6, fluid circulates from supply pipe A of GHX Module Supply-Return Runout AA′ through Circuit #1 and back through return pipe A′ of GHX Module Supply-Return Runout AA′. Fluid further circulates from supply pipe A of GHX Module Supply-Return Runout AA′ to supply pipe B of GHX Header Section BB′ through Circuit #2 and back through return pipe B′ of GHX Header Section BB′ and back through return pipe A′ of GHX Module Supply-Return Runout AA′. Finally, fluid circulates from supply pipe A of GHX Module Supply-Return Runout AA′ to supply pipe B of GHX Header Section BB′ to supply pipe C of GHX Header Section CC′ through Circuit #3 and back through return pipe C′ of GHX Header Section CC′ and back through return pipe B′ of GHX Header Section BB′ and back through return pipe A′ of GHX Module Supply-Return Runout AA′

In other words, in a direct return system, the flow paths get longer and longer as the GHX circuits go out farther and farther. It is clear that a molecule of water flowing through circuit #1 travels a shorter distance and returns faster to the circulation pump than a molecule of water flowing through circuit #2 or circuit #3.

FIG. 7 shows a reverse return GHX system in embodiments of the disclosed technology. In the prior art, reverse return GHX Headers generally are more complex to design, take more effort to build, and can require more total pipe (and hence offer a higher total pressure drop from the beginning to end of the system) compared to direct return GHX Headers. The return pipe of the GHX Module Supply-Return Runout may be longer in the reverse return case compared to the direct return case.

To understand a reverse return system, and still referring to FIG. 7, return pipe A′ of the GHX Module Supply-Return Runout can be longer in the reverse return case. The reverse return system has three flow paths. First, fluid circulates from a supply pipe of Pipe Pair A through Circuit #1 and then continues on into the return pipe of Pipe Pair B; then into the return pipe of Pipe Pair C and finally into the return pipe of Pipe Pair A. Second, fluid circulates from a supply pipe of Pipe Pair A to the supply pipe of Pipe Pair B through Circuit #2 and then continues on into the return pipe of Pipe Pair C and out into the return pipe of Pipe Pair A. Third, fluid circulates from supply pipe of Pipe Pair A to the supply pipe of Pipe Pair B to the supply pipe of Pipe Pair C to Circuit #3, and then continues on into the return pipe of Pipe Pair A.

In other words, in a reverse return system, the flow path is near equal or substantially equal (with a usual tolerance of not more than 10% difference) for each length of each GHX circuits. This can be seen even in the descriptions of the three path flows above: they are all about the same length (compare this to the descriptions of the three path flows in the direct return section and notice how those are progressively longer).

In a reverse return system, the flow paths within the GHX Module section are ideally the same length for each molecule of water, regardless of whether the molecule goes through Circuit #1 or through Circuit #3. In these systems, the return pipe of the GHX Module Supply-Return Runout (pipe A′ in FIG. 7) is connected to the farthest GHX Circuit. For comparison's sake, in direct return systems the return pipe of the GHX Module Supply-Return Runout (A′) is connected to the closest GHX Circuit. Reverse return systems are inherently flow-balancing, which has made them the standard in the geothermal industry.

FIG. 8 shows a diagram of the reverse return system of FIG. 7. The reverse return pairs are represented by the crossover symbol 816. The initial/supply flow paths are represented by hollow circles 812, and the return paths are represented by squares 814. (Any symbol or color differentiation may be used. The symbols shown here are by way of example). Note that while the supply flow path is identical to that in the direct return system, the return flow path is different in a reverse return system. Recall that in the direct return systems, the GHX Circuit (e.g., circuit 122 comprising the U-tube) receives a “downward flowing” supply flow and shifts it into an “upward flowing” return flow (note that “down” and “up” refer to the top and bottom of figure and not necessarily to physical directions). In reverse return systems, the GHX Circuit is more like a relay that sends the flow cascading farther down all the way to the last final reverse return GHX Header section (C in FIG. 7). To explain this difference, additional reverse return-specific terminology is required. The “parent/child/sibling” nomenclature needs to be modified and augmented for reverse return systems. While reverse return header components have parent/child and sibling relationships (like they do in direct return systems), reverse return systems have two unique additional relationships based on the same components.

A parallel flow path is defined as one in which a flow path (and component) divides into two or more parallel flow paths (and components). Note that parallel does not mean equal. It merely means that the flow branches off in two or more directions. When a parent is attached to two or more children, the flow splits off in parallel. A series flow path is defined as one in which a flow path continues in one direction from one component to another component. When a parent has one child, the flow travels from parent to child in series. As long as the implementer of methods of the disclosed technology recognizes that parallel flow involves three or more component elements (a parent and at least two children) and two or more flow directions, and that series flow involves two component elements (a parent and a child, for example, or, in the case of reverse return systems, a sibling and a sibling) and one flow direction, he or she is ready to proceed to the next section.

Series Sibling Relationships: In reverse return systems (like the one seen in the figure), the supply pipe of Pipe Pair A is the parent of both Circuit #1 and the supply pipe of Pipe Pair B. Circuit #1 and the supply pipe of Pipe Pair A are siblings. As such, the flow into the siblings from the parent is in parallel, just like it is in direct return systems. However, between these two siblings there is another flow path. This is one in which the return pipe of Circuit #1 flows into the return pipe of Pipe Pair B. In other words, even though Circuit #1 and Pipe Pair B are siblings, there is a series flow from one sibling to another. With reverse return systems, sibling relationships are hybrids—they have both parallel and serial flow characteristics. This relationship is called the series sibling relationship.

In embodiments of the disclosed technology, siblings are vertically stacked. In direct return systems vertically stacked siblings are always in parallel flow. In reverse return systems, however, vertically stacked siblings are in both parallel and series flow. This series flow aspect in the series sibling relationship is responsible for the other relationship that is unique in reverse return systems, the reverse child-parent relationship.

In reverse return systems, as shown in FIG. 7 and diagrammed in FIG. 8, fluid flows from the return pipe of one GHX Header pair to the return pipe of another GHX Header pair. This is identical in the direct return systems except that in reverse return systems, visually the return flow path is heading “down” rather than up. In the direct return systems, the return flow path is heading “up”. As a result, components in reverse return systems that are connected for return flow, but actually flow in the “down” direction, are like the reverse of parent-child relationships. Hence, they are termed “reverse child-parent relationships.” Now referring specifically to FIG. 8, these reverse return child-parent relationships become apparent. The supply and return flows are more or less in parallel and in the same direction (“down”). Only at the last GHX Circuit (that is, circuit #03) does the return flow actually begin flowing in the return (“up”) direction to return pipe A′ of the GHX Module Supply-Return Runout.

Again, this can be seen in FIG. 7 in which the return pipes B′ and C′ of the GHX Headers flow in parallel with the “supply” flow in supply pipes B and C until the last GHX Circuit #3, at which point the return flow reverses course and flows through the return pipe A′ of the GHX Module Supply-Return runout and heads into the return direction. Expressed in another way, in reverse return systems, GHX Circuits are like relays that send the flow farther down the GHX Module. It is only at the last GHX Circuit, where the flow of fluid heads back via a return pipe to the start, such as to a building which is being cooled by way of the fluid. This is diagrammed with corresponding indicators (in this case, squares) showing the return path, which corresponds to the supply path (in this case, circles) except for the last return path from the final header section. That is, with the exception of the last return path, each segment of each flow path has an equivalently shown return path connecting between the two elements between which fluid flows. A crossover icon or other indicator indicates the further flow to a child element. This diagramming method allows for neat and concise showing of reverse return paths and for a user to manipulate properties (such as defined above with respect to FIG. 1) of any component within a system and see how properties of the fluid flow are changed.

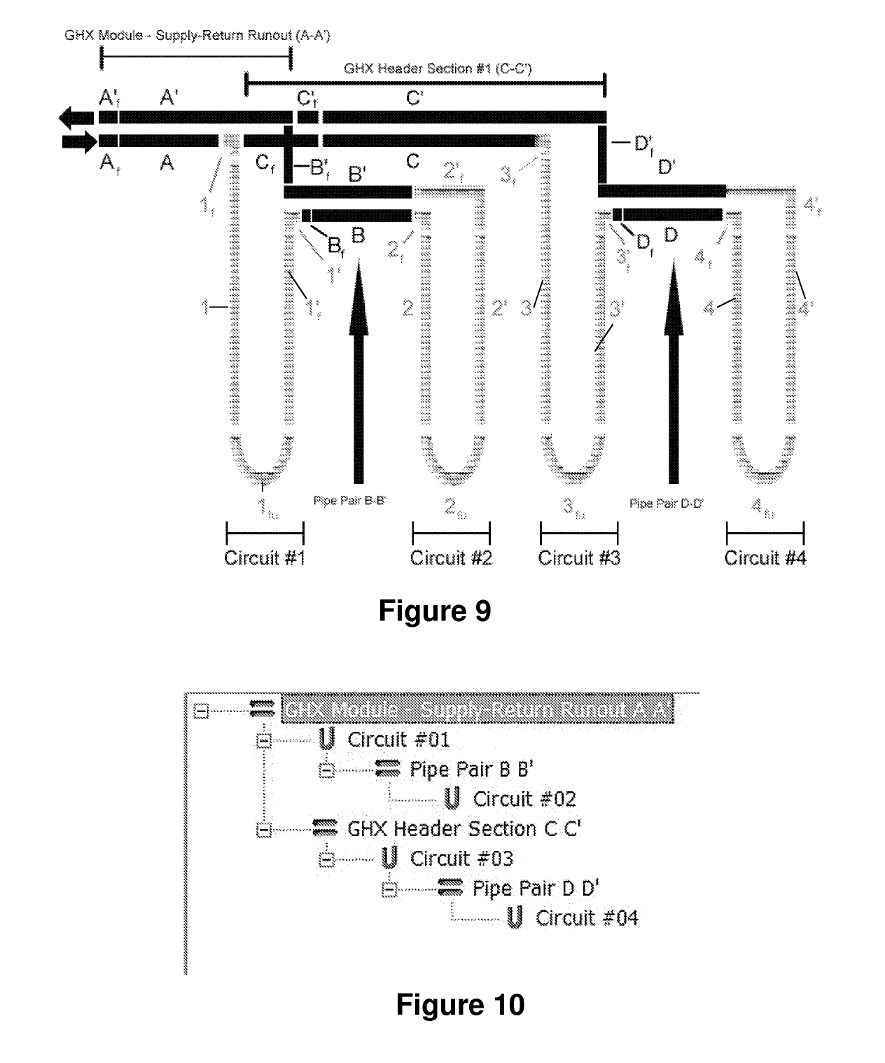

FIG. 9 shows a complex four-circuit direct-return GHX Module. The GHX Module Supply-Return Runout, the GHX Header pipe pairs and their associated fittings are in solid black. The GHX Circuits and their associated fittings comprise horizontal white lines for purposes of illustration. Between each connection a space has been added to visibly separate different sections of the system for easy comparisons with the layout structure shown in FIG. 10. To ensure clarity, each individual component in the figure is listed below:

| Supply/Return Pipe Pairs: | GHX Circuits |
|---|---|
| A_{f}-A-A′-A′_{f} | 1_{f}-1-1_{fu}-1′-1′_{f} |
| B_{f}-B-B′-B′_{f} | 2_{f}-2-2_{fu}-2′-2′_{f} |
| C_{f}-C-C′-C′_{f} | 3_{f}-3-3_{fu}-3′-3′_{f} |
| D_{f}-D-D′-D′_{f} | 4_{f}-4-4_{fu}-4′-4′_{f} |

Note that each supply/return pipe pair comprises four subcomponents and each GHX Circuit comprises five subcomponents, as mentioned above in the basic description of the two basic components (the pipe pair and the GHX Circuit).

FIG. 10 is a diagrammatic view of the complex four-circuit direct-return GHX Module shown in FIG. 9, as created in embodiments of the disclosed technology. The rather complex drawings of FIG. 9, comprising four circuits, two sub-circuits in parallel, and so forth, are reduced to eight lines which can be easily scanned, understood, manipulated, and used to make fluid dynamics calculations. The major components shown are pipe pairs and GHX circuits. Each two GHX circuits are in series (circuit #1 and circuit #2 for example) and are connected to each other by a supply pipe (e.g., pipe B of Pipe Pair BB′). The return pipe (e.g., B′ of Pipe Pair BB′) brings the entire series of two parallel circuits back into return pipe A′ of the GHX Module Supply Return Runout AA′.

As noted above, parallel flow paths are vertically stacked and have one parent and at least two children (or at least two siblings looking at it from the child's perspective). This means that circuit #1 and the supply pipe C of GHX Header Section CC′ are parallel flow paths. Circuit #1 and supply pipe C of GHX Header Section CC′ are siblings and share supply pipe A of the GHX Module Supply-Return Runout AA′ as a parent. This becomes clear in FIG. 10 where the flow branches from supply pipe A of the GHX Module Supply-Return Runout Pipe AA′ and into Circuit #1 and supply pipe C of the GHX Header Section CC′.

Referring back to FIG. 9, it may appear that pipe pair BB′ and Circuit #3 are in parallel/are siblings as well, since they are vertically stacked. However, now referring to FIG. 10, it should be clear that this type of confusion is alleviated based on the layout technique of embodiments of the disclosed technology. Again, a parallel flow path is defined as one in which a flow path (and component) divides into two or more parallel flow paths (and components). Pipe pair BB′ and circuit #3, although vertically stacked, do not branch out from the same predecessor component. Therefore they cannot be siblings and cannot be in parallel.

Referring again to FIG. 9, there are also serial flow paths. Serial flow paths are stacked with indentation and each parent can have only one child. This means that supply pipe A of the GHX Module Supply-Return Runout AA′—Circuit #1—supply pipe B of Pipe Pair BB′—Circuit #2 are in series, since they are stacked with indentation and each component has only one child and one parent. Another major series flow path is supply pipe A of the GHX Module Supply-Return Runout AA′—supply pipe C of the GHX Header Section CC′—Circuit #3—supply pipe D of Pipe Pair DD′—Circuit #4.

It is important to note that the visual “grammar” that the current embodiment uses is not shown to scale. The graphics used to describe the pipes and their relationships are identical in size even if the underlying pipe properties are different. For example, in FIG. 1, circuit 123 could be 100 ft deep and circuit 124 could be 200 feet deep.

Referring now back to FIG. 2, it should be understood how to read the linear map displayed therein. This is a two dimensional map of a piping system, which may be any piping system with supply and return flow (geothermal, home heating, or the like). At least one single indicator representative of both a supply flow pipe and a return flow pipe is shown, here, the indicator is the “=” or the words “GHX Module—Supply-Return Runout” on the third line/level, and similar such labels. At least one circuit pipe of the piping system is connected between the supply and the return pipe, in an actual implantation of a piping system diagrammed in a method of carrying out embodiments of the disclosed technology. As such, at least one indicator representative of a circuit pipe (a circuit pipe, as used in the claims, may be any terminal load with known equivalent resistance, such as a fan coil) is also depicted. In FIG. 2, such circuit pipes are indicated with the “U” shape or the description “Circuit #01,” and the like. Each of indicators is placed in a linear directional manner, in this case, top to bottom, indicative of a direction of flow of fluid through at least a part of the piping system. That is, for example, fluid flows linearly through GHX Header Section #01 to Circuit #02 to Circuit #03 (rows 5 through 8 of FIG. 2). However, part of the diagram/map is depicted out of linear order, as the flow Circuit #04 (row/level 10 of FIG. 2) then flows back into “GHX Module—Supply-Return Runout” (row/level 3 of FIG. 2). In any case, as shown in FIG. 2, in embodiments of the map and method of creating the map, one indicator per line/level is depicted.

Still referring to FIG. 2, placement of indicators representative of a circuit pipes is offset transversely to said linear direction, indicating supply and return of flow to a preceding return pipe. That is, for example, “Circuit #01” (row/level 4) is indented to the right (which is a transverse direction to the up/down linear flow of the map), indicating that it is a child pipe of “GHX Module—Supply-Return Runout” (row/level 3). In a piping system made from this diagram, fluid flows from the GHX module to the circuit, and then back into (directly or by way of further indented items) the GHX module.

Further shown in FIG. 2 are two variations of piping systems. One indicator indicates a direct flow system (as defined above). This is the “=” and/or corresponding written description stating as such. Another indicator is the “X” or crossover symbol as shown in the Figure (e.g., row/level 5), indicating reverse return flow and a reverse return flow pipe.

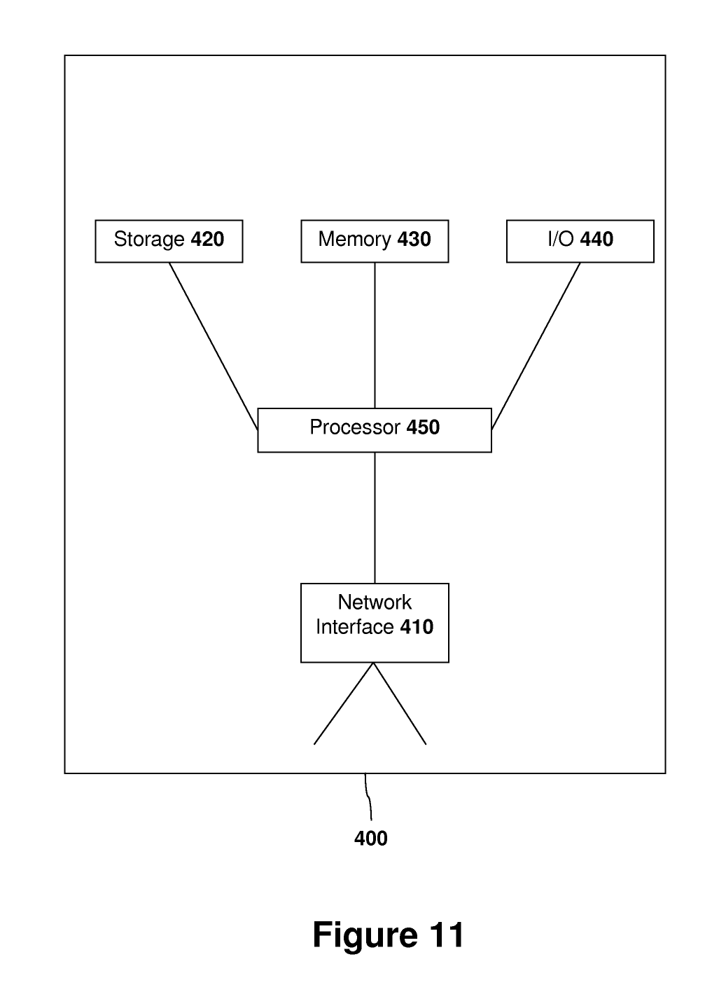

The connectors, that is, in this case shown in FIG. 2, in this hierarchical tree, represent flow between two essential components of the piping system. Thus, a line connects from row 1 to row 2, row 2 to row 3, row 3 to row 4 and 11, 11 to 12, 12 to 13 and 20, and so forth. Each row, as shown here, is a level. If the map were drawn in another orientation, then the levels would be depicted at different tabbed positions, for example, instead of rows. In embodiments, a computer input device can be used (such as a mouse or keyboard) to manipulate this display, such as to collapse (hide) indented branches from a parent or expand (show) indented branches, making a complex system easy to view, understand, and manipulate. An electronic display, such as described with reference to FIG. 11, may further be employed. So too, by way of a computer input device, a selection of an indicator associated with a supply and return flow pipe may remove from exhibiting on the electronic display all indicators representative of child pipes to the selected pipe. Or, a selection may allow a user to change properties (as described with reference to FIG. 1) of a pipe in the pipe system. Such a change, in embodiments of the disclosed technology, causes a cascaded update of properties of other pipes in the system. Such properties might include flow rate, anticipated pressure drop, and the like.

FIG. 11 shows a high level diagram of a device on which methods of the disclosed technology are carried out in embodiments of the disclosed technology. Device 400 comprises a processor 450 that controls the overall operation of the computer by executing the device's program instructions which define such operation. The device's program instructions may be stored in a storage device 420 (e.g., magnetic disk, database) and loaded into memory 430 when execution of the console's program instructions is desired. Thus, the device's operation will be defined by the device's program instructions stored in memory 430 and/or storage 420, and the console will be controlled by processor 450 executing the console's program instructions. A device 400 also includes one or a plurality of input network interfaces for communicating with other devices via a network (e.g., the internet). The device 400 further includes an electrical input interface. A device 400 also includes one or more output network interfaces 410 for communicating with other devices. Device 400 also includes input/output 440 representing devices which allow for user interaction with a computer (e.g., display, keyboard, mouse, speakers, buttons, etc.). One skilled in the art will recognize that an implementation of an actual device will contain other components as well, and that FIG. 9 is a high level representation of some of the components of such a device for illustrative purposes. It should also be understood by one skilled in the art that the method and devices depicted in the prior figures may be implemented on a device such as is shown in FIG. 9.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

We claim:

1. A linear map of a pipe system, comprising:
at least one single indicator representative of both a supply flow pipe and a return flow pipe, wherein at least one circuit pipe of said pipe system is connected between said supply and said return pipe;
at least one indicator representative of a said circuit pipe;
placement of each of said indicators in a linear manner, indicative of a direction of flow of fluid through at least a part of said pipe system.

2. The linear map of claim 1, wherein one indicator per line is depicted on said linear map.

3. The linear map of claim 2, wherein said placement of at least one said indicator representative of a said circuit pipe is offset transversely to said linear direction, indicating supply and return of flow to a preceding return pipe.

4. The linear map of claim 3, wherein a said single indicator representative of both a supply flow pipe and a return flow pipe corresponds to direct flow and another said single indicator representative of both a supply flow pipe and a return flow pipe corresponds to reverse return flow.

5. The linear map of claim 4, further comprising connectors between two said indicators corresponding to a path of flow between pipes represented by said indicators.

6. The linear map of claim 5, wherein said linear map is manipulatable by way of selection of indicators on said linear map.

7. The linear map of claim 6, wherein a said selection of a said indicator associated with a said supply and return flow pipe removes from exhibiting all indicators representative of child pipes to said selected pipe.

8. The linear map of claim 7, wherein a said selection of a said indicator allows for a change in properties of a said pipe of said pipe system, wherein such a said change triggers a cascaded update of properties of other pipes in said system.

9. The linear map of claim 8, wherein a property of said properties is a physical property of a pipe.

10. The linear map of claim 1, wherein said linear map is a hierarchical tree.

11. A method of two-dimensional mapping of a piping system with supply and return flow, said method proceeding as follows:
exhibiting at least one single indicator representative of both a supply flow pipe and a return flow pipe, wherein at least one circuit pipe of said piping system is connected between said supply and said return pipe;
exhibiting at least one indicator representative of a said circuit pipe;
placement of each of said indicators in a linear directional manner, indicative of a direction of flow of fluid through at least a part of said piping system.

12. The method of claim 11, wherein one said indicator per level is depicted.

13. The method of claim 12, wherein said placement of at least one said indicator representative of a said circuit pipe is offset transversely to said linear direction, indicating supply and return of flow to a preceding return pipe.

14. The method of claim 13, wherein in said mapping of a said piping system, a said single indicator is exhibited corresponding to a direct flow circuit between a, and a representative of a, supply flow pipe and a return flow pipe, and another said single indicator is exhibited corresponding to a return flow circuit between a, and representative of a, supply flow pipe and a return flow pipe.

15. The method of claim 14, further comprising connectors between two said indicators corresponding to a path of flow between pipes represented by said indicators.

16. The method of claim 15, wherein said method is carried out by way of a computer input device and said exhibiting is on an electronic display.

17. The method of claim 16, wherein, by way of a computer input device, a said selection of a said indicator associated with a said supply and return flow pipe removes from exhibiting on said electronic display all indicators representative of child pipes to said selected pipe.

18. The method of claim 17, wherein a said selection of a said indicator allows for a change in properties of a said pipe of said pipe system, wherein such a said change triggers a cascaded update of properties of other pipes in said system.

19. The method of claim 18, wherein a property of said properties is a physical property of a pipe.

20. The method of claim 11, wherein said piping system is exhibited in a hierarchical tree.
